(19) United States
(12) Patent Application Publication
(10) Pub. No.: US 2016/0037734 A1
(43) Pub. Date: Feb. 11, 2016

(54) FLOWERPOT COMPRISING ADJUSTABLE ARMS AND INDEPENDENT REMOVABLE SNAP PINS FOR COUPLING AND SUPPORTING TO RAILINGS, WALLS OR OTHER SUPPORTS

(71) Applicant: Bama S.P.A., Altopascio (IT)

(72) Inventor: Renzo BAIOCCHI, Montecarlo (IT)

(21) Appl. No.: 14/766,975

(22) PCT Filed: Sep. 27, 2013
(86) PCT No.: PCT/IB2013/002141

§ 371 Date: Aug. 10, 2015

(51) Int. Cl. A01G 9/02; A47G 7/04

(52) U.S. Cl. CPC A01G 9/028; A47G 7/04

(57) ABSTRACT

A flowerpot (100) comprising adjustable arms (104) and independent removable snap pins (105) for safe coupling to railings, walls or other supports comprising a container (101) having a lateral edge (102), the adjustable arms (104) comprising a vertical branch (104a) for engaging the container (101) to the support and a horizontal branch (104b) able to be coupled with a lower portion of the lateral edge (102), characterized in that the lateral edge (102) comprises at least two successive trough trenched seats (106) able to be aligned and coupled with at least two successive trough trenched seats (107) comprised in the horizontal branch (104b) via at least one independent removable snap pin (105).

The present invention relates to a flowerpot comprising adjustable arms and independent, removable snap pins for coupling and supporting to railings, walls or other supports.

A flowerpot equipped with adjustable arms for coupling and supporting to railings, walls or other supports is described in the patent application N. IT2003FI0001120030115 published on Jul. 16, 2004 and comprises coupling arms which are adjustable to adapt to the thickness of the support provided for supporting the flowerpot. Moreover the described flowerpot comprises a container provided with at least one retractable lower support able to contact the outer face of the support. Each coupling arm is perpendicular to the flowerpot, has a vertical branch to embrace the support and a horizontal branch perpendicular to the support, and is engageable in a linearly adjustable position inside a corresponding seat formed in the bottom portion of the edge of the flowerpot. The seats comprised in the bottom portion of the edge of the flowerpot present at least one or a series of snap pins downwards oriented and also some lower trough protrusions. The horizontal branch of each coupling arm form a plurality of through seats for these snap pins and for these lower protrusions in order to differently position the flowerpot depending on the thickness of the support provided. In addition a safety pin can be provided for being inserted inside the trough protrusions previously coupled with the corresponding trough seat of the coupling arm in order to better guarantee the locking and the safety of the support and for retaining against sliding.

The problem of the described flowerpot is that it is difficult to easily manage the adjustments of position of the flowerpot depending on the support thickness and to quickly uncouple the flowerpot from the support.

Aim of the present invention is to provide a flowerpot comprising adjustable arms and independent removable snap pins for coupling and supporting to railings, walls or other supports easy to disengage from the support and to manage the adjustments of position on the support.

According to the present invention, a flowerpot comprising adjustable arms and independent removable snap pins for coupling and supporting to railings, walls or other supports is realized, as defined in claim 1.

For a better understanding of the present invention a preferred embodiment is described, by way of non limitative example, referring to the accompanying drawings, in which:

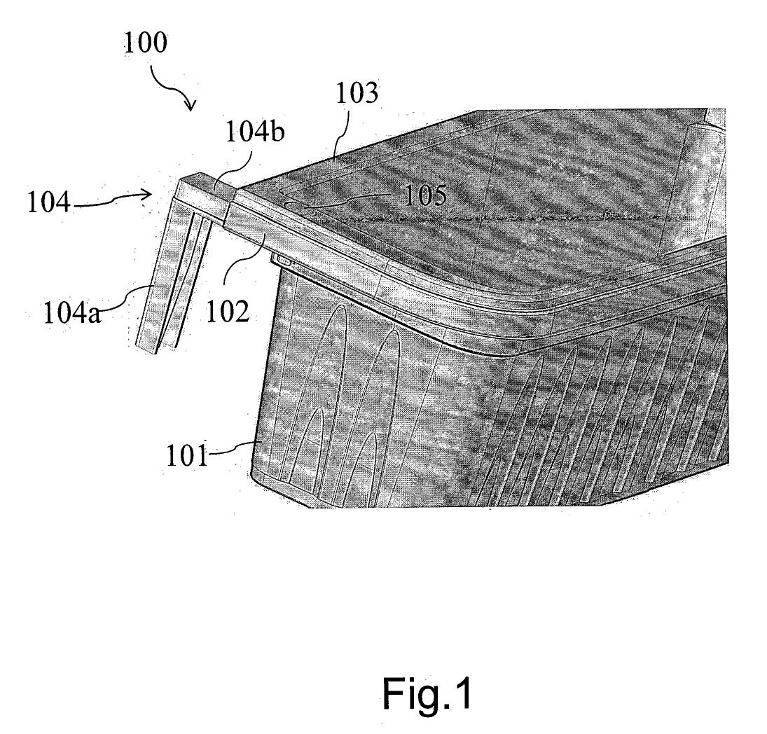

FIG. 1 shows a first schematic three-dimensional view of an assembled flowerpot comprising adjustable arms and independent removable snap pins for coupling and supporting to railings, walls or other supports, according to the invention;

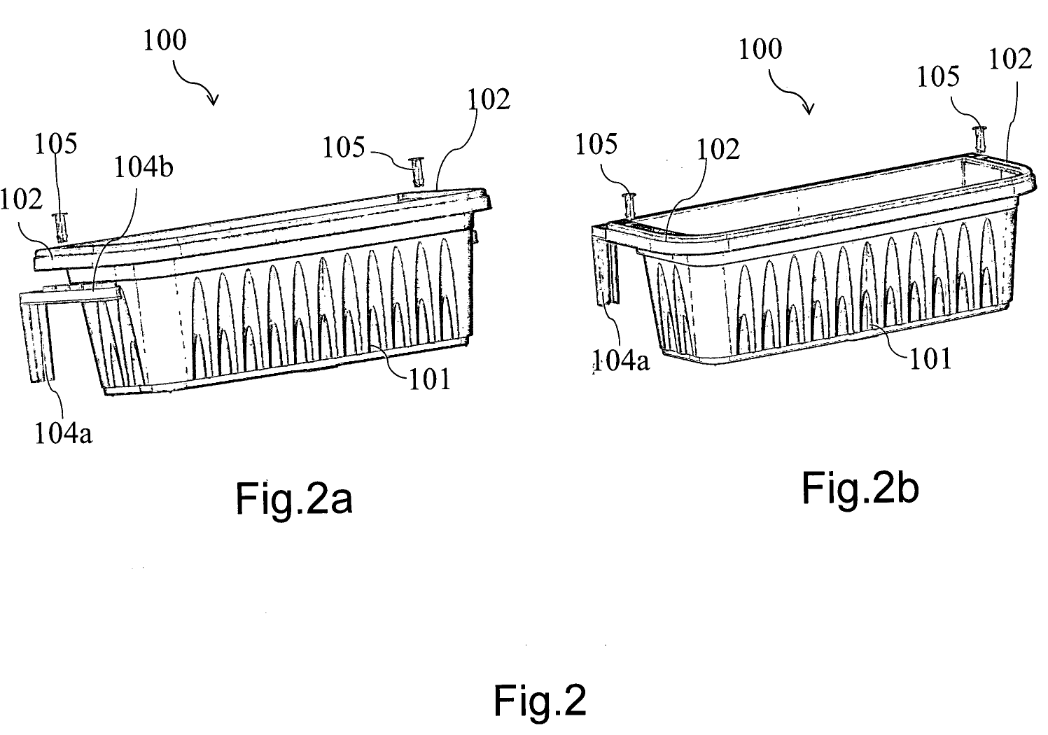

FIGS. 2a-2b show schematic three-dimensional views of the assembly of the flowerpot comprising adjustable arms and independent removable snap pins for coupling and supporting to railings, walls or other supports, according to the invention;

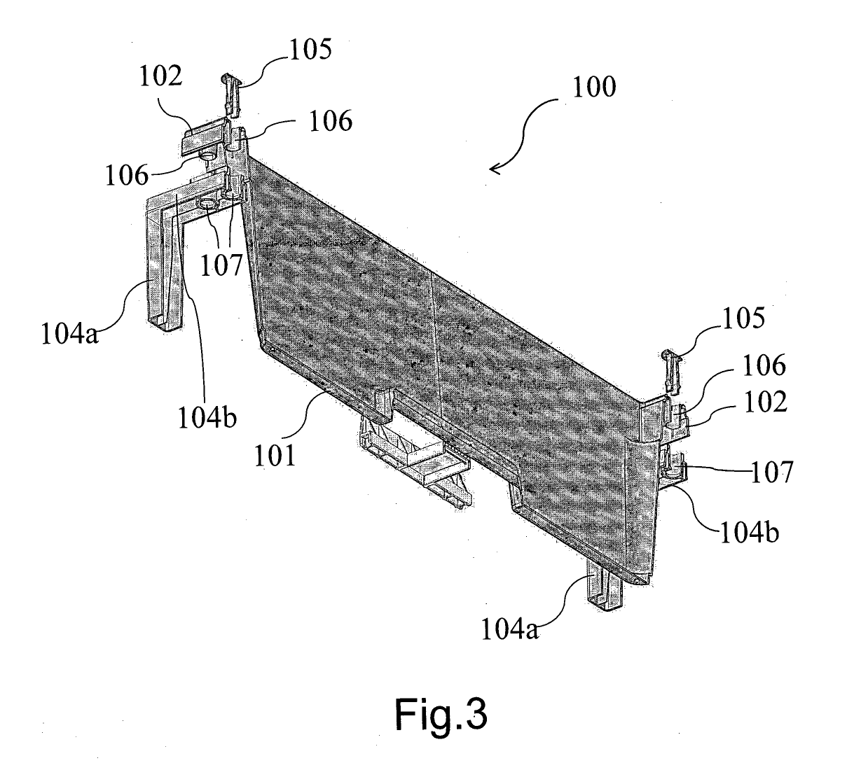

FIG. 3 shows a schematic three-dimensional section view of the assembling of the flowerpot comprising adjustable arms and independent removable snap pins for coupling and supporting to railings, walls or other supports, according to the invention;

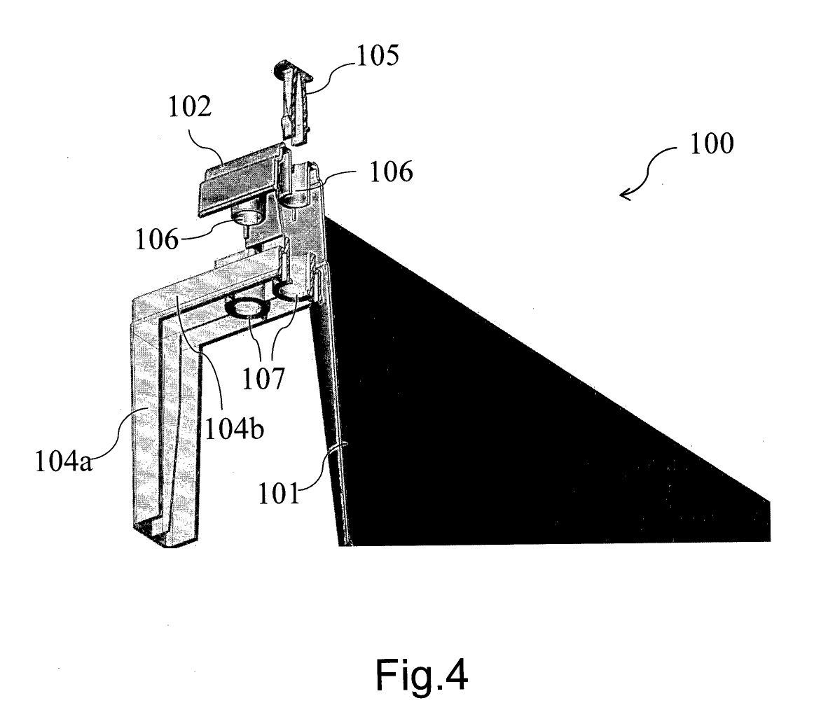

FIG. 4 shows a schematic three-dimensional zoomed section view of the assembling of the flowerpot comprising adjustable arms and independent removable snap pins for coupling and supporting to railings, walls or other supports, according to the invention;

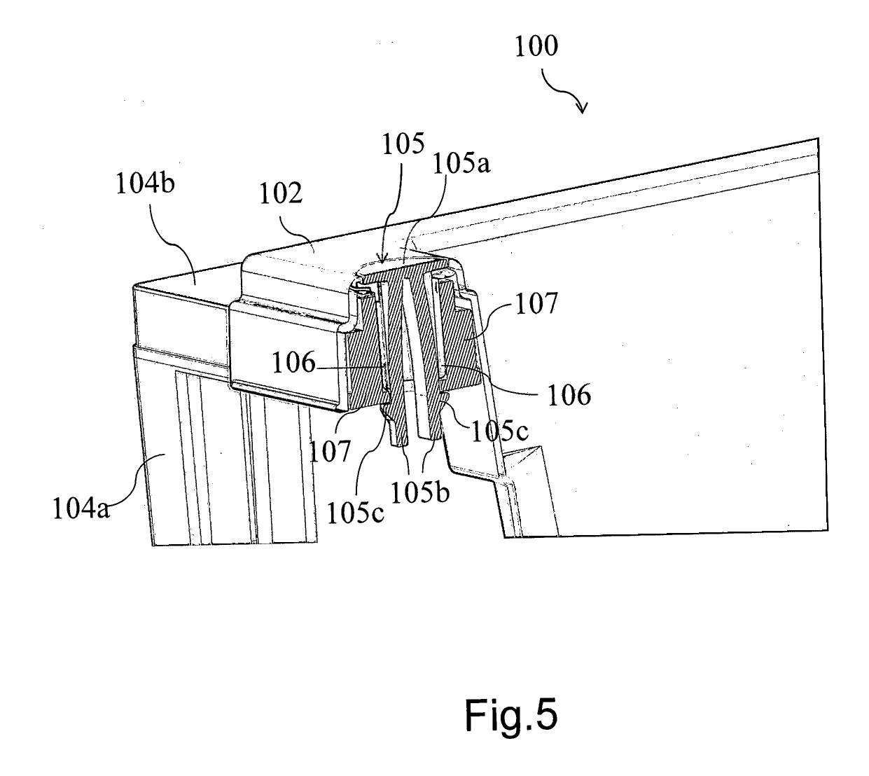

FIG. 5 shows a schematic three-dimensional zoomed section view of the assembled flowerpot comprising adjustable arms and independent removable snap pins for coupling and supporting to railings, walls or other supports, according to the invention;

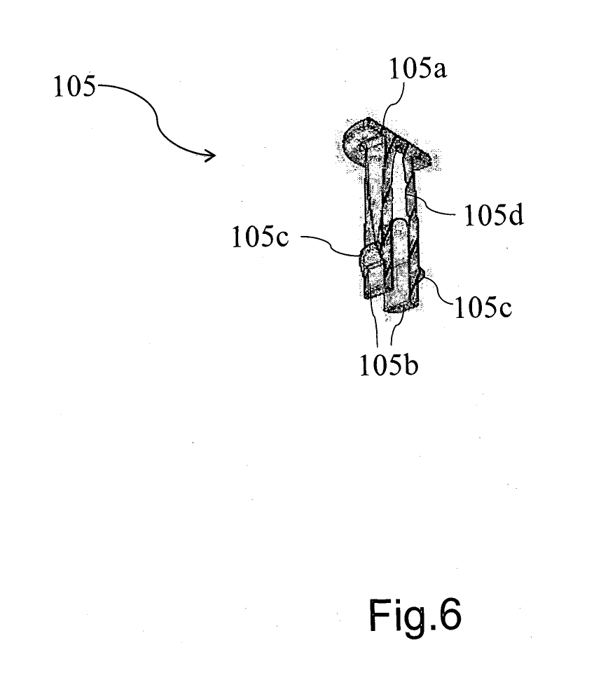

FIG. 6 shows a schematic three-dimensional view of an embodiment of the independent removable snap pins, according to the invention.

Referring to those figures, and in particular to FIGS. 1 and 2, a flowerpot 100 comprising adjustable arms and independent removable snap pins for coupling and supporting to railings, walls or other supports is shown, according to the invention. In more details, the flowerpot 100 comprises a container 101 having a lateral edge 102 and a rear edge 103. The flowerpot 100 also comprised two lateral arms 104, only one being shown in the figures, for coupling and supporting the container 101 to railings, walls or other supports, not shown in the figures. Each arm 104 comprises a vertical branch 104a for engaging the container 101 to the support not shown and a horizontal branch 104b to be coupled with the lower portion of the lateral edge 102. In particular, the flowerpot 100 is equipped with independent removable snap pins 105 for the stable and safe fixing of the arms 104 to the lateral edge 102 of the container 101.

As better shown in the FIGS. 3 and 4, the lateral edge 102 of the container 101 comprises a plurality of trough trenched seats 106 able to be aligned' and coupled with correspondent trough trenched seats 107 comprised in the horizontal branch 104b of the arms 104.

More in details, advantageously, according to the invention, the trough trenched seats 106 can enter inside the trough trenched seats 107 so that the container 101 can be coupled to the arms 104.

According to an aspect of the invention, the trough trenched seats 106 and 107 are cylindrical.

Advantageously, according to the invention, a stable and safe fixing of the container 101 coupled to the arms 104 is obtained inserting the removable snap pins 105 inside the trough trenched seats 106.

According to an aspect of the invention, as better shown in the FIG. 5, the removable snap pins 105 comprises an upper head 105a and two lower vertical appendices 105b having bottom lateral protrusions 105c and contoured so that they insert and click into place to fix. the lateral edge 102 to the horizontal branch 104a of the arms 104.

According to another aspect of the invention, the removable snap pins 105 are made of plastics.

According to further aspect of the invention, each removable snap pin 105 comprises a plastic plug 105d between two lower vertical appendices 105b. The plug 105d extends from the bottom of the upper head 105a to the bottom lateral protrusions 105c bottom of the vertical appendices 105b and has a length roughly equal to 15 mm.

Advantageously, according to the invention, the arm 104 can be moved at different positions depending on the distance at which the flowerpot 100 has to be fixed on the support. This is possible because all the trough trenched seats 106 are identical each other and all the trough trenched seats 107 are identical each other. Therefore, each trough trenched seat 106 can be coupled with each trough trenched seat 107.

Moreover, advantageously, according to the invention, a single removable snap pins 105 can be inserted into the trough trenched seats 106 and click into place at the end of the trough trenched seats 107 to fix the lateral edge 102 to the horizontal branch 104a of the arms 104.

According to an aspect of the invention, only one removable snap pin 105 is inserted per arm 104.

According to another aspect of the invention, a plurality of removable snap pins 105 is inserted per arm 104.

Advantageously, according to the invention, the flowerpot comprising adjustable arms and independent removable snap pins for coupling and supporting to railings, walls or other supports allows an easy disengagement from the support.

Moreover, with the flowerpot comprising adjustable arms and independent removable snap pins for coupling and supporting to railings, walls or other supports it is possible to easily manage the adjustments of flowerpot position on the support.

At the end, the flowerpot comprising adjustable arms and independent removable snap pins for coupling and supporting to railings, walls or other supports according to the invention is that it is adaptable to a plurality of supports.

It should be clear that other modifications and embodiments carried out to the described flowerpot comprising adjustable arms and independent removable snap pins for coupling and supporting to railings, walls or other supports can be done falling within the scope of the present invention, as defined in the appended claims.

1. A flowerpot, comprising:
adjustable arms having a vertical branch and a horizontal branch, the horizontal branch including at least two successive trough trenched seats;
at least one independent removable snap pin;
a container having a lateral edge, the lateral edge, the lateral edge comprises includes at least two successive trough trenched seats able configured to be aligned and coupled with the at least two successive trough trenched seats with the at least one independent removable snap pin.

2. A flowerpot according to claim 1, wherein the at least two successive trough trenched seats are configured for to internally fitting to fit into the at least two successive trough trenched seats comprised in the horizontal branch.

3. A flowerpot according to claim 1, wherein the trough trenched seats are cylindrical.

4. A flowerpot according to claim 1, wherein the trough trenched seats are identical to each other.

5. A flowerpot according to claim 1, wherein the trough trenched seats are identical to each other.

6. A flowerpot according to claim 1, wherein the at least one removable snap pin includes an upper head and two lower vertical appendices having bottom lateral protrusions able configured to click into place at an end of the trough trenched seats.

7. A flowerpot according to claim 1, wherein the removable snap pins are made of plastics.

8. A flowerpot according to claim 6, wherein the at least one removable snap pin includes a plastic plug between the two lower vertical appendices and extending from a bottom of the upper head to the bottom lateral protrusions and a bottom of the vertical appendices has a prefixed length.
